(19) United States
(12) Patent Application Publication
(10) Pub. No.: US 2016/0355051 A1
(43) Pub. Date: Dec. 8, 2016

(54) System for Creating a Work of Art

(71) Applicant: Pen Your Love, LLC, Dallas, TX (US)

(72) Inventors: Catherine Mary Husted, Irving, TX (US); Laura Louise Daly, Dallas, TX (US)

(21) Appl. No.: 15/172,857

(22) Filed: Jun. 3, 2016

Related U.S. Application Data
(60) Provisional application No. 62/170,406, filed on Jun. 3, 2015.

(51) Int. Cl. B44C 5/02

(52) U.S. Cl. CPC B44C 5/02

(57) ABSTRACT

A system for creating a work of art that commemorates a significant life event may include an art kit having a plurality of design elements and a mounting board to which the design elements are affixed to create an art scene. The art kit may further include special note tags for event attendees to write sentiments about a celebrated guest. The special note tags may then be secured to the mounting board to cover portions of the art scene and thereby complete the work of art.

### CROSS-REFERENCE TO RELATED APPLICATIONS

This application claims the benefit of U.S. Provisional Patent Application Ser. No. 62/170,406 filed Jun. 3, 2015, and entitled “System for Creating a Work of Art”, which is incorporated herein by reference in its entirety.

### TECHNICAL FIELD

The present disclosure relates to a system and a method for creating a work of art commemorating a significant life event.

### BACKGROUND

Guest books and memory books are conventional commemorative tools that allow event attendees to express thoughts acknowledging significant life events of the celebrated guest. These sentiments are collected in one location and saved for posterity. Typical events at which such commemorative tools are used include, but are not limited to, Bridal Showers, Weddings, Baby Showers, Birthdays, Graduations, Quinceaneras, Anniversaries and Faith-Based events, such as Baptisms.

Such conventional commemorative tools are typically viewed only periodically rather than being displayed for regular viewing.

### SUMMARY

The present disclosure is directed to a system and a method for creating a work of art that commemorates a significant life event. In some implementations, the system comprises an Art Kit having a plurality of design elements. The method may comprise selectively arranging design elements of the Art Kit to form a permanent and commemorative work of art. In an implementation, the method further comprises allowing event attendees to share sentiments about a celebrated guest written on Special Note Tags, then arranging the Special Note Tags on other elements of the Art Kit to complete the work of art.

In some implementations, the Art Kit may comprise design elements including template designs, decorative fabrics, decorative papers, and decorating materials such as paints, lace, beads, sequins, ribbon, paper flowers, fabric flowers, jewels, glitter glue, hook and loop tape, and cork. The Art Kit may further comprise a canvas or foam mounting board to which the design elements are affixed to create an Art Scene. The Art Kit may further comprise Special Note Tags for event attendees to write personalized messages about the celebrated guest. Then the Special Note Tags may be secured to the mounting board using pushpins and/or glue to cover portions of the Art Scene and thereby create and complete the commemorative work of art.

In one implementation, the template design may be a Pre-Printed Doll that, in combination with other design elements of the Art Kit and affixed to a mounting board, create an Art Scene comprising a Bride or a young woman in a Quinceanera dress.

In another implementation, the template design may be a Pre-Printed Baby Doll that, in combination with other design elements of the Art Kit and affixed to a mounting board, create an Art Scene comprising a baby in a Bassinet or under a Quilt.

In other implementations, appropriate to a variety of celebrations, the template designs may include Outdoor Scenes, Birthday Cakes, Wrapped Gifts, Wedding Cakes, Articles of Clothing, Quilts and Hot Air Balloons, for example, that, in combination with other design elements of the Art Kit and affixed to a mounting board, create various different Art Scenes.

In each implementation, the Special Note Tags containing personalized messages by event attendees are then secured to the mounting board to cover portions of the Art Scene, thereby creating and completing a permanent commemorative work of art.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a flowchart identifying the decision-making process Consumers will make in selecting design elements of an Art Kit to create a commemorative work of art that is event specific, in accordance with various implementations of the disclosure.

FIG. 2 illustrates a flowchart identifying the decision-making process Consumers will make in selecting design elements of an Art Kit to create a work of art commemorating events such as Bridal Showers, Weddings, or Quinceaneras, in accordance with an implementation of the disclosure.

FIG. 3 illustrates a perspective view of a partially completed Art Scene for a Bridal Shower created from certain design elements of an Art Kit, including a black Art Board and a Pre-Printed Doll, in accordance with an implementation of the disclosure.

FIG. 4 illustrates a perspective view of a completed Art Scene for a Bridal Shower created from further design elements of the Art Kit added to the Art Board shown in FIG. 3, including one possible combination of Dress Top, Dress Skirt, and optional accessories, including a Veil, Jewelry and a Bouquet, in accordance with an implementation of the disclosure.

FIG. 5 illustrates a perspective view of a completed work of art comprising Special Note Tags from the Art Kit pinned to the Dress Skirt of the Art Scene for a Bridal Shower shown in FIG. 4, in accordance with an implementation of the disclosure.

FIG. 6 illustrates a perspective view of another completed work of art comprising Special Note Tags from an Art Kit pinned to the Dress Skirt of an Art Scene for a Bridal Shower, wherein the Consumer selected a white Art Board instead of a black Art Board, in accordance with an implementation of the disclosure.

FIG. 7 illustrates a flowchart identifying the decision-making process Consumers will make in selecting design elements of an Art Kit to create a work of art commemorating events such as Baby Showers or Baptisms, in accordance with an implementation of the disclosure.

FIG. 8 illustrates a perspective view of a partially completed Art Scene created from certain design elements of an Art Kit including a white Art Board and a Pre-Printed Baby Doll, in accordance with an implementation of the disclosure.

FIG. 9 illustrates perspective views of various implementations of completed Art Scenes created from further design elements of the Art Kit added to the Art Board shown in FIG. 8, the Art Scenes including a Baby with a Quilt, a Baby in a Bassinet, and a Baby Quilt with Personalized Image/Information, in accordance with an implementation of the disclosure

FIG. 10A illustrates a perspective view of a completed work of art comprising a Baby with a Quilt, with the Special Note Tags from the Art Kit pinned to the Quilt shown in FIG. 9, in accordance with an implementation of the disclosure.

FIG. 10B illustrates a perspective view of a completed work of art comprising a Baby in a Bassinet, with the Special Note Tags from the Art Kit pinned to the Bassinet shown in FIG. 9, in accordance with an implementation of the disclosure.

FIG. 10C illustrates a perspective view of a completed work of art comprising a Baby Quilt with Personalized Image/Information, showing the Special Note Tags from the Art Kit pinned to the Quilt shown in FIG. 9, all centered around an image of the celebrated newborn Baby and birth date, in accordance with an implementation of the disclosure.

FIG. 11 illustrates a flowchart identifying the decision-making process Consumers will make in selecting design elements of an Art Kit to create a work of art commemorating events such as Birthday Parties, Anniversaries, Graduations or other significant life event, in accordance with an implementation of the disclosure.

FIG. 12 illustrates front views of various implementations of completed Art Scenes created from design elements of an Art Kit added to a white Art Board, the Art Scenes including a Wrapped Gift and a Graduation Quilt, in accordance with an implementation of the disclosure.

FIG. 13A illustrates a front view of a completed work of art comprising a Wrapped Gift, with the Special Note Tags from the Art Kit pinned to the Art Board covered in decorative fabric/paper and decorative ribbon shown in FIG. 12, in accordance with an implementation of the disclosure.

FIG. 13B illustrates a front view of a completed work of art comprising a Graduation Quilt, with the Special Note Tags from the Art Kit pinned to the Art Board covered in decorative fabric/paper shown in FIG. 12, all centered around an image of the celebrated graduate with graduation date, in accordance with an implementation of the disclosure.

### DETAILED DESCRIPTION

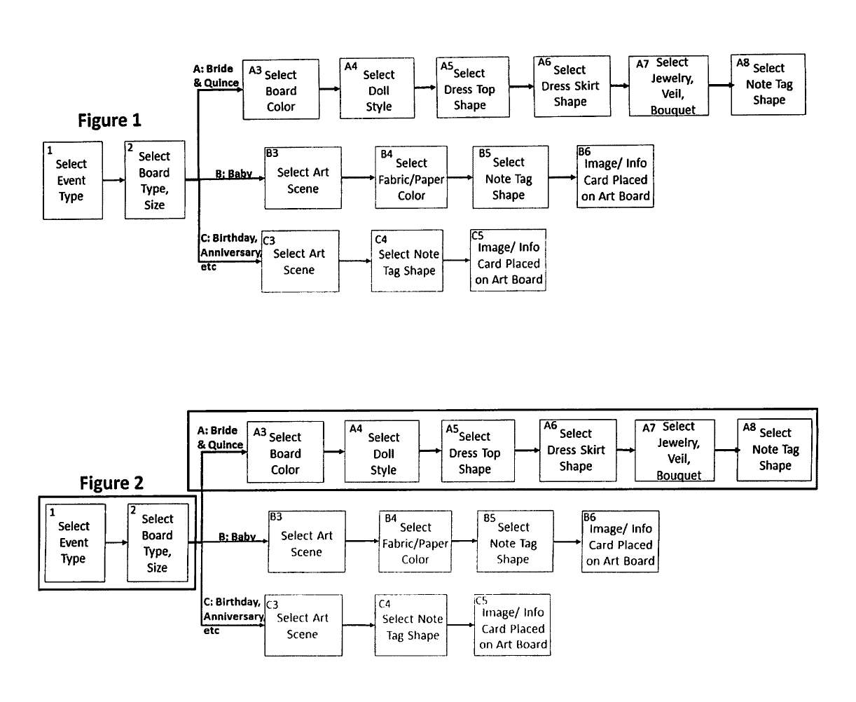

FIG. 1 illustrates a flowchart identifying the decision-making process Consumers will make in selecting design elements of an Art Kit to create a commemorative work of art that is event specific, in accordance with various implementations of the disclosure. Regardless of the type of Art Kit, the decision-making process begins with the same first two steps. Different implementations of the decision-making process take place after the first two steps.

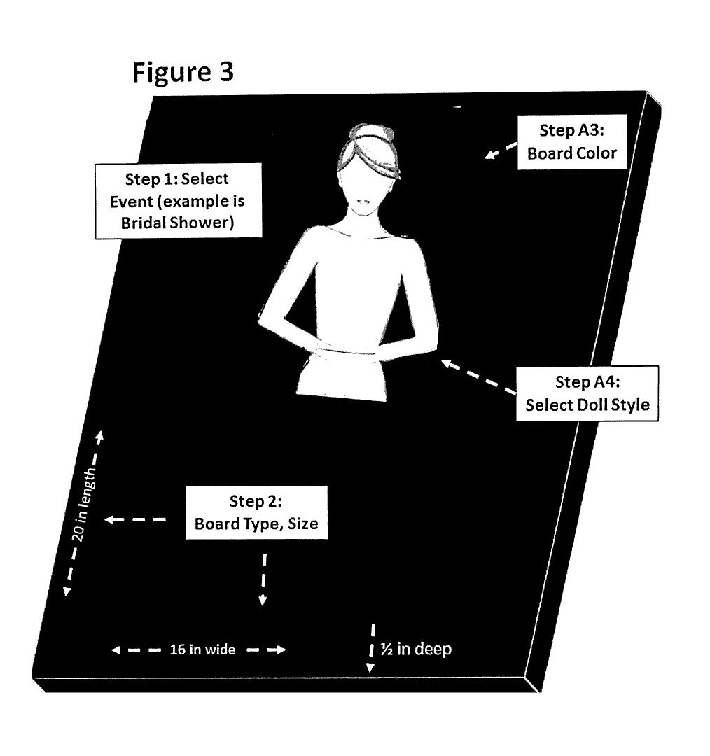

FIG. 2 illustrates a flowchart identifying the decision-making process Consumers will make in selecting design elements of an Art Kit to create a work of art commemorating events such as Bridal Showers, Weddings, or Quinceaneras.

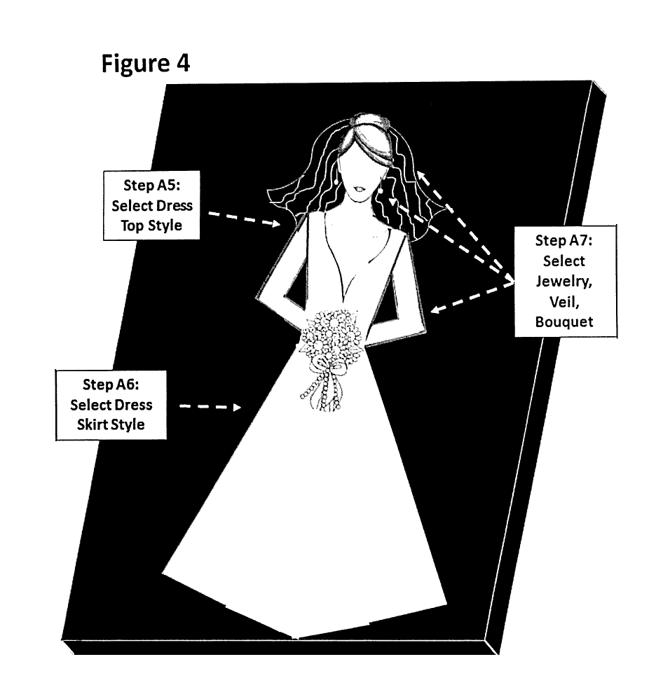

FIG. 3 illustrates a perspective view of a partially completed Art Scene for a Bridal Shower created from certain design elements of an Art Kit. The flowchart of FIG. 2 outlines the steps of the method for creating the partially completed Art Scene of FIG. 3.

In Step 1, the Consumer selects an Event, which thereby selects the relevant Art Kit. In the example of FIG. 3, the Event is a Bridal Shower. The Bridal Shower Art Kit will share similar choices with Art Kits used for Weddings and Quinceaneras.

In Step 2, the Consumer selects the size and material for the Art Board included in their Art Kit. In an implementation, the Art Board of FIG. 3 may be a 16-inch by 20-inch stretched cotton canvas stapled to a wooden frame approximately ½ inch deep. Other stretched canvas sizes will be offered, including but not limited to: 18 inch by 24 inch stretched canvas, and 12 inch by 24 inch stretched canvas. Further, other materials may be used for the Art Board, including but not limited to foam board.

In Step A3, the Consumer selects the color for the Art Board included in their Art Kit. In an implementation, the Art Board of FIG. 3 is black. White and other colored boards will be offered. Additionally, all Art Boards may be covered in Tulle or another see-through fabric to add depth and texture to the finished piece of art. For black Art Boards, black Tulle (or similar fabric) may be used. For white Art Boards, the fabric covering may include white Tulle, or another color Tulle or other fabric may be used based on the design.

In Step A4, the Consumer selects one of a variety of Pre-Printed Doll types. In the implementation shown in FIG. 3, the Pre-Printed Doll is facing forward with her hair up in a “bun.” The Pre-Printed Doll may be printed on paper and may be affixed to the Art Board using spray or stick glue, along with quilting tacks attached using a quilt-tacking gun. The Pre-Printed Doll may be attached about an inch from the top of the Art Board to allow for the attachment of additional design elements from the Art Kit.

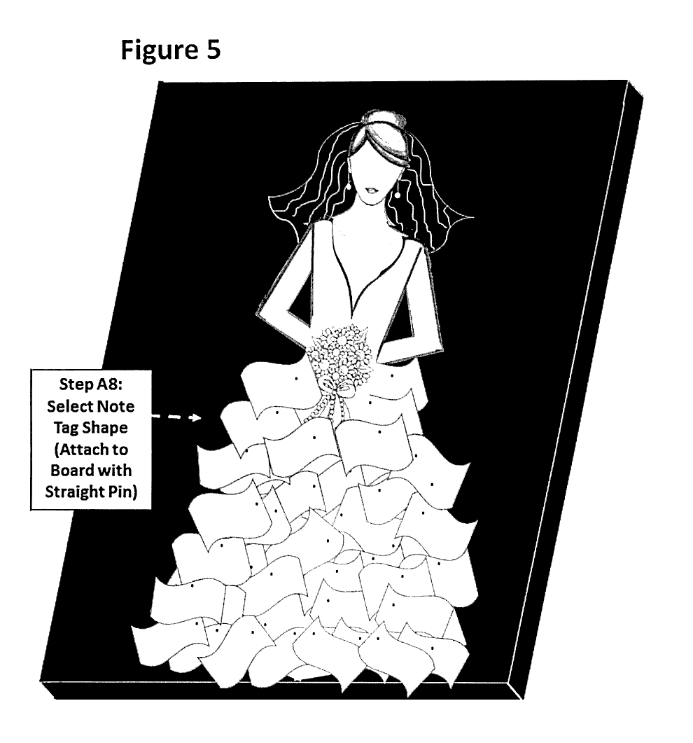

FIG. 4 illustrates a perspective view of a completed Art Scene for a Bridal Shower created from further design elements of the Art Kit added to the Art Board shown in FIG. 3, including Dress and Accessory elements. The flowchart of FIG. 2 continues the steps of the method for creating the completed Art Scene of FIG. 4.

In Step A5, the Consumer selects one of a variety of Dress Top Styles. In the implementation shown in FIG. 4, the Dress Top Style is the ‘Deep V’ style. Other Dress Top Style choices include, but are not limited to, the ‘Sweetheart Strapless,’ the ‘Sweetheart with Half Sleeves,’ the ‘Pearl with Cap Sleeves,’ the ‘Square Neck with Cap Sleeves,’ and the ‘Boat Neck with Half Sleeves.’ The Dress Top, which may be made of decorative paper or fabric, may be affixed to the Art Board over the Pre-Printed Doll with spray/stick glue.

In Step A6, the Consumer selects one of a variety of Dress Skirt Styles. In the implementation shown in FIG. 4, the Dress Skirt Style is the ‘Full Skirt.’ Other Dress Skirt Style choices include, but are not limited to, the ‘Ball Gown’ and the ‘Narrow with Scalloped Edge.’ The Dress Skirt may be made of decorative paper or fabric, and may include decorative elements such as Tulle trim. The Dress Skirt may be affixed with spray/stick glue to a piece of cork, cut to the same shape as the selected Dress Skirt Style. The piece of cork may have adhesive backing, and the adhesive side of the cork may be placed against the Art Board to affix the Dress Skirt to the Art Board.

In Step A7, the Consumer selects optional Accessory elements. In the implementation shown in FIG. 4, the Consumer has selected Jewelry, a Veil and a Bouquet. Jewelry may include, but is not limited to earrings, necklaces, tiaras and bracelets made of crystal, pearl, beads and other materials. These items may be affixed to the Pre-Printed Doll on the Art Board using sticky backs that may be included on the Jewelry items selected or with spray/stick glue. Veils may be made of Tulle and come in varying neutrals such as cream, gold and silver, as well as the full spectrum of colors to provide a variety of color choices for Brides and Quinceaneras. Veils may be attached to the Pre-Printed Doll and Art Board with spray/stick glue and a quilting tack using a quilt-tacking gun. Bouquets may be made from fabric flowers and other fabric or plastic materials to create the look of flowers, greenery, and other decorative elements contained in bouquets. Bouquets include a wide range of colors and flower types, and decorative components. Bouquets may be attached to the Art Board using hook and loop tape, spray/stick glue, and/or a quilting tack and quilt-tacking gun.

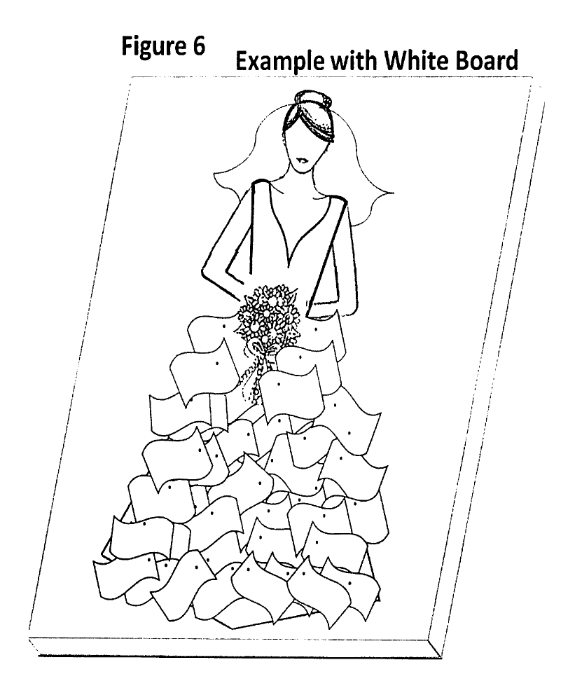

FIG. 5 illustrates a perspective view of a completed work of art formed by pinning Special Note Tags from the Art Kit to the Dress Skirt shown in FIG. 4. The flowchart of FIG. 2 continues the steps of the method for creating the completed work of art of FIG. 5.

In Step A8, the Consumer selects the Special Note Tags upon which event attendees will write their sentiments. The Special Note Tags may be made of paper and pre-cut into proprietary designs, including but not limited to: squares with scalloped edges, circles with scalloped edges, “wedding bells,” and other wavy geometric figures.

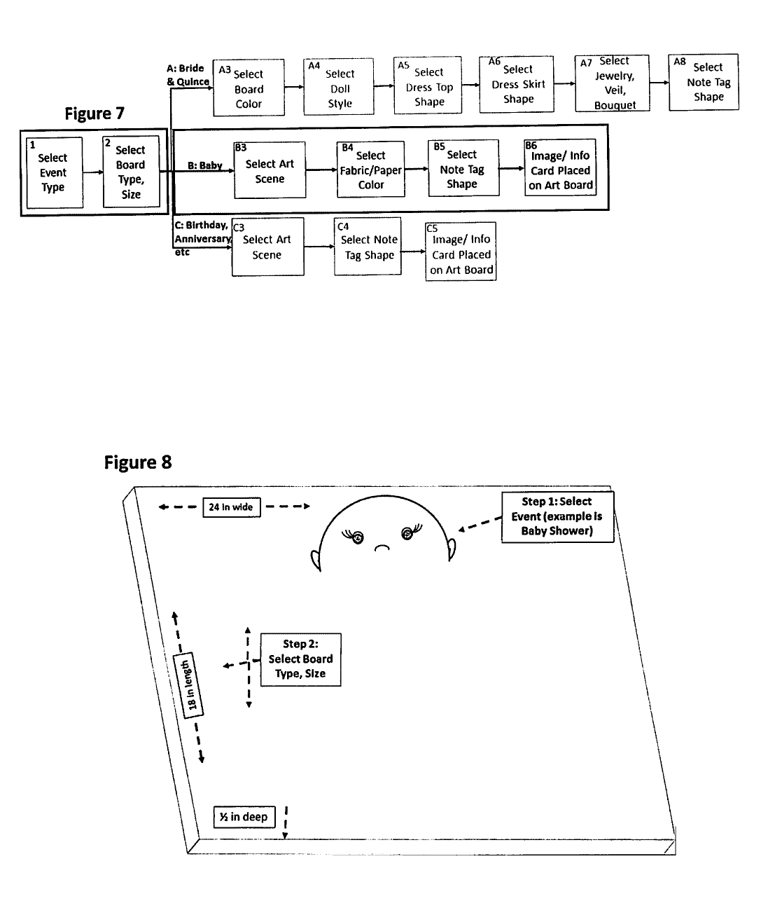

At the commemorative event for the celebrated guest, such as the Bridal Shower, event attendees may write their thoughts and sentiments on the Special Note Tags using felt tipped pens included in the Art Kit. The Special Note Tags are then pinned to the Dress Skirt and surrounding area using straight pins, and as needed, stick glue. The straight pins may be secured by pressing them through the Special Note Tag, Dress Skirt, cork backing and the Art Board. Attaching the Special Note Tags creates a three-dimensional aspect to the Dress Skirt and completes the work of art shown in FIG. 5 to commemorate the Bridal Shower. FIG. 6 illustrates a perspective view of a similar completed work of art for a Bridal Shower, but on a white Art Board rather than a black Art Board. White may be one of the Art Board color offerings in the Art Kit.

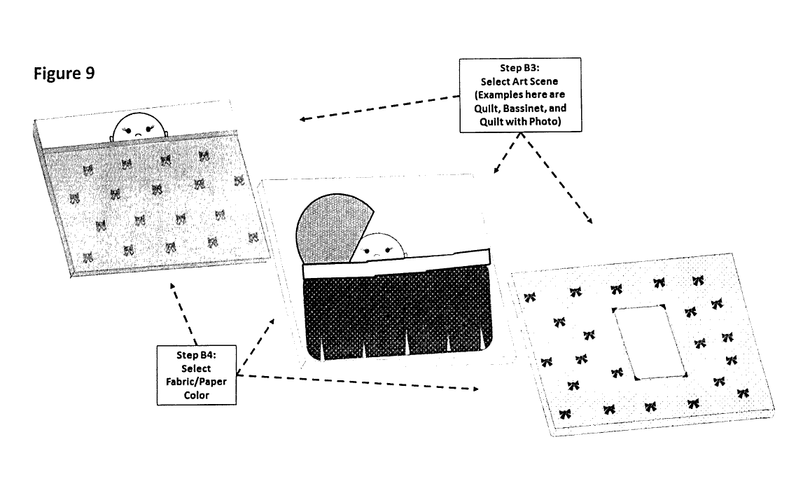

FIG. 7 illustrates a flowchart identifying the decision-making process Consumers will make in selecting design elements of an Art Kit to create a work of art commemorating events such as Baby Showers or Baptisms.

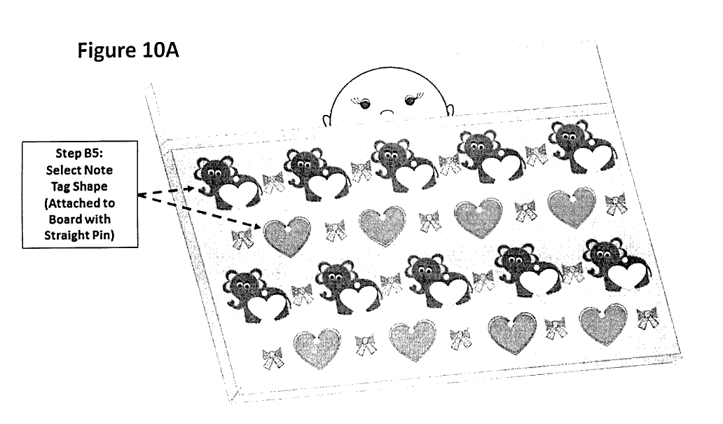

FIG. 8 illustrates a perspective view of a partially completed Art Scene created from certain design elements of an Art Kit including a white Art Board and a Pre-Printed Baby Doll. The flowchart of FIG. 7 outlines the steps of the method for creating the partially completed Art Scene of FIG. 8.

In Step 1, the Consumer selects an Event, which thereby selects the relevant Art Kit. In the example of FIG. 8, the Event is a Baby Shower.

In Step 2, the Consumer selects the size and material for the Art Board included in their Art Kit. In an implementation, the Art Board of FIG. 8 may be an 18-inch by 24-inch stretched cotton canvas stapled to a wooden frame approximately ½ inch deep. Other stretched canvas sizes will be offered, including but not limited to: 16-inch by 20-inch stretched canvas, and 12-inch by 24-inch stretched canvas. Further, other materials may be used for the Art Board, including but not limited to foam board.

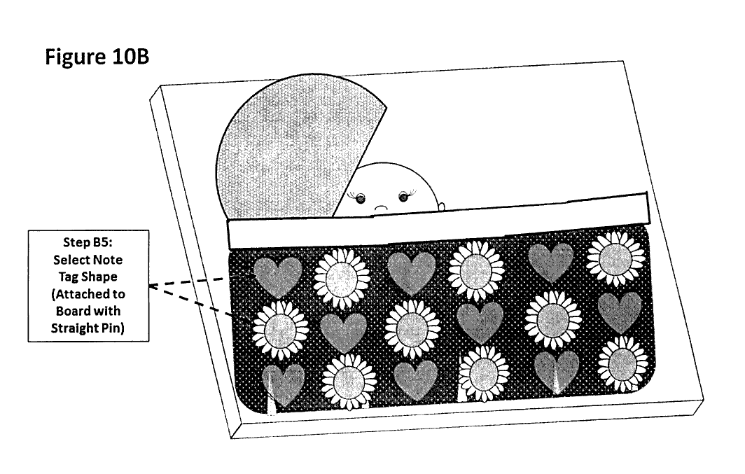

FIG. 9 illustrates perspective views of various implementations of completed Art Scenes created from further design elements of the Art Kit added to the Art Board shown in FIG. 8, the Art Scenes including a Baby with a Quilt, a Baby in a Bassinet, and a Baby Quilt with Personalized Image/Information. The flowchart of FIG. 7 continues the steps of the method for creating the completed Art Scenes of FIG. 9.

In Steps B3 and B4, the Consumer selects the Art Scene and Colors, including a selection of the color of the Art Board. FIGS. 8 and 9 show a white Art Board. Other colors will be offered for both the canvas and the foam board.

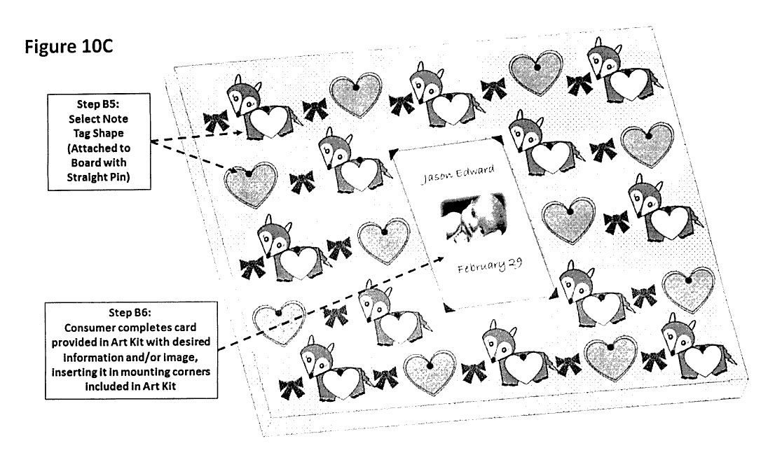

In Step B3, the Consumer will also have multiple Art Scene choices for the Baby Shower event. Three (3) examples include: Baby with Quilt, Baby in Bassinet, and Baby Quilt with Personalized Photo/Information. Baby with Quilt shown in FIG. 9 includes a Pre-Printed Baby Doll tucked under the hem of a “Quilt” and Baby in Bassinet shown in FIG. 9 includes a Pre-Printed Baby Doll peaking out from a “Bassinet. In some implementations, the Pre-Printed Baby Doll is printed on paper and is affixed to the Art Board using spray/stick glue; along with quilting tacks attached using a quilt-tacking gun. As shown in FIG. 8, the Pre-Printed Baby Doll may be attached close to the top of the Art Board to allow for the largest available area, and optimum placement of Special Note Tags (shown in FIGS. 10A, 10B and 10C).

Referring again to FIG. 8 and FIG. 9, if the Consumer selects the “Baby with Quilt” Art Scene in Step B3, the Art Board may be covered with adhesive-backed cork across part of the width and up to the full width, which varies depending on the size of the Art Board. The adhesive-backed cork may further be positioned 3-6 inches from the top of the Art Board, which again varies based on the size of Art Board selected. The adhesive side of the cork is pressed against the front of the Art Board to attach the cork thereto. The Art Board and the cork layer may then be covered with cotton batting that wraps around the back of the Art Board. The cotton batting may be affixed with spray/stick glue on the front and stapled to the backside of the canvas frame of the Art Board.

Step B4 indicates the selection of colors. The Baby Shower Art Kits will be offered in a variety of colors, offering the Consumer selections related to the general pallet of decorative fabrics/decorative papers, as well as ribbon and other accents. Decorative paper may be layered toward the top of the Art Board to create “sheets” upon which the Pre-Printed Baby Doll lays. The remainder of the Art Board may be covered with decorative fabric or other decorative paper to create the effect of a Quilt cover. The decorative fabric or paper may wrap around the back of the Art Board. The decorative fabric or paper may be affixed to the cotton batting with spray/stick glue and stapled to the backside of the canvas frame of the Art Board. The Quilt look and feel may be completed with the addition of small ribbons tied into “bows” and attached in traditional quilt pattern, using quilting tacks and a quilt-tacking gun. The bows are laid out in a pattern that leaves rooms for Special Note Tags to be attached later at the event during which guests will write their sentiments.

Referring again to FIG. 8 and FIG. 9, if the Consumer selects the “Baby in Bassinet” Art Scene in Step B3, the “Bassinet Base” may be formed by placing a piece of adhesive-backed cork, sticky side down, on the Art Board. The adhesive-backed cork may extend across part of the width and up to the full width, which varies depending on the size of the Art Board. The adhesive-backed cork may further be positioned to cover approximately ⅔rds of the Art Board, which again varies based on the size of Art Board selected. A piece of card stock cut to the same size as the cork may be affixed to the cork Bassinet Base with spray/stick glue. A piece of cotton batting, cut to the same height as the cork/card stock, but slightly wider, may then be glued to the card stock and wrapped around the sides and bottom of the Art Board. The cotton batting may be affixed to the back edges of the Art Board with spray/stick glue and then stapled.

Step B4 indicates the selection of colors. The Baby Shower Art Kits will be offered in a variety of colors, offering the Consumer selections related to the general pallet of decorative fabrics/decorative papers, as well as ribbon and other accents. The items forming the Bassinet Base described above may then be covered with decorative fabric/paper cut to the same size as the cotton batting so as to cover the front of the Art Board and wrap around the edges onto the back of the Art Board. The decorative fabric/paper may be affixed with spray/stick glue to the cotton batting and the back of the Art Board, and further affixed with staples to the back of the Art Board. In FIG. 9, the base of the Bassinet is shown in dark brown fabric with small white dots, topped with a white lip with brown trim forming the top edge.

The “Bassinet Hood” may be formed using a cut piece of cardstock, covered with batting and decorative fabric/paper that is complementary to the decorative fabric/paper used to cover the Basinet Base. The Bassinet Hood may be slipped under the top edge of the Bassinet Base and glued to the Art Board with spray/stick glue and further affixed with a quilting tack applied with a quilt-tacking gun. In FIG. 9, the Bassinet Hood is shown in medium blue fabric with brown trim and sits 1-2 inches from the top of the Art Board. It is slipped approximately 1 inch under the top of the Bassinet Base. The Pre-Printed Baby Doll may then be slipped under the top of the Bassinet Base, and partially behind the Bassinet Hood. The Pre-Printed Baby Doll may be affixed to the Art Board with spray/stick glue.

Referring to FIG. 9, if the Consumer selects the “Baby Quilt with Personalized Image/Information” in Step B3, this Art Scene is created in a manner similar to the Baby with Quilt, but without the Pre-Printed Baby Doll or the “sheet” at the top of the Art Board. Instead, the “Quilt” is built to cover the entire Art Board. The Art Kit may include Mounting Corners, which may be placed in the center of the completed “Quilt” to retain an image, such as a photograph of the baby after birth, for example, or information, such as the name and date of birth. The Art Kit may include a piece of card stock for the Consumer's use in printing an information card to be retained by the Mounting Corners. However, the Consumer may use another type of material to complete the personalization of the Baby Quilt.

FIGS. 10A, 10B and 10C illustrate front views of a completed work of art formed by pinning Special Note Tags from the Art Kit to the three (3) different Art Scenes depicted in FIG. 9, respectively. The flowchart of FIG. 7 continues the steps of the method for creating the completed works of art of FIGS. 10A, 10B and 10C.

In Step B5, the Consumer selects the Special Note Tags upon which event attendees will write their sentiments. The Special Note Tags may be made of paper and pre-cut into proprietary designs, including but not limited to: Foxes, Bears, Owls, Lions, Elephants, Bibs, Trains, Cars, Flowers, and Hearts.

At the commemorative event for the celebrated guest, such as the Baby Shower, event attendees may write their thoughts and sentiments on the Special Note Tags using felt tipped pens included in the Art Kit. The Special Note Tags are then pinned to the Quilt or Bassinet and surrounding area using straight pins, and as needed, stick glue. The straight pins may be secured by pressing them through the Special Note Tag, Quilt/Bassinet material, cork backing and the Art Board.

FIG. 10A depicts the Baby with Quilt as a completed work of art with Elephant and Heart Note Tags. FIG. 10B depicts the Baby in Bassinet as a completed work of art with Sunflower and Heart Note Tags.

For the “Baby Quilt with Personalized Image/Information,” the flowchart of FIG. 7 includes an additional Step B6 wherein the Consumer inserts an image of the newborn and/or prints information on a piece of cardstock in the Art Kit. FIG. 10C depicts the Baby Quilt with Personalized Image/Information as a completed work of art with Fox and Heart Note Tags, plus an image of a newborn along with his name and birthdate printed on a piece of cardstock and inserted by the Consumer into the Mounting Corners to complete the design.

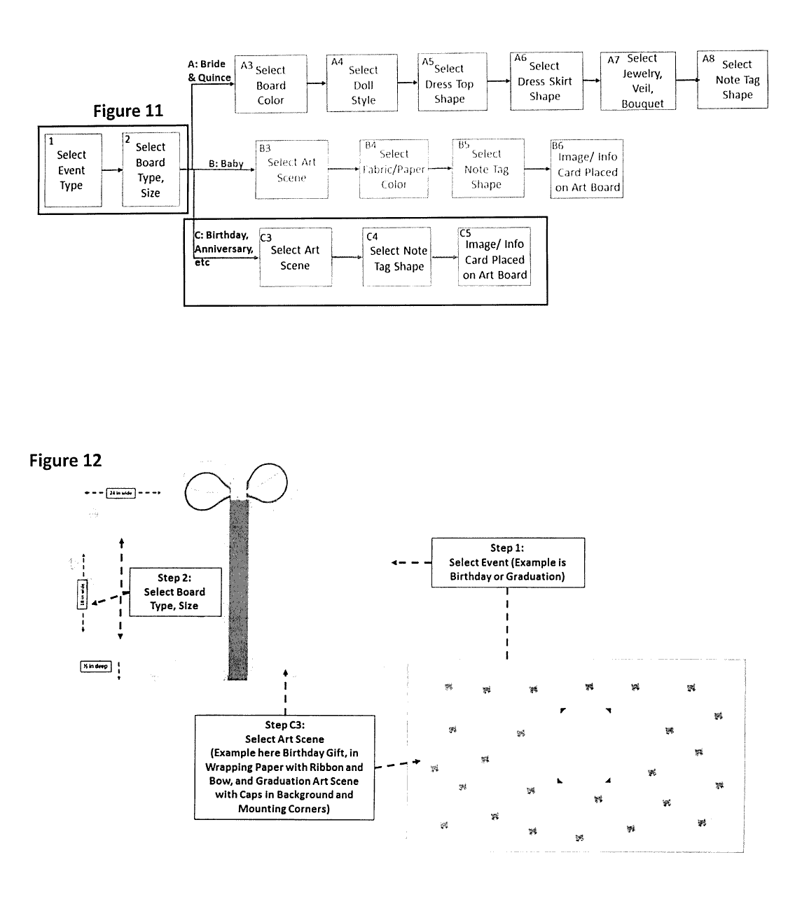

FIG. 11 illustrates a flowchart identifying the decision-making process Consumers will make in selecting design elements of an Art Kit to create a work of art commemorating events such as Birthday Parties, Anniversaries, and Graduations.

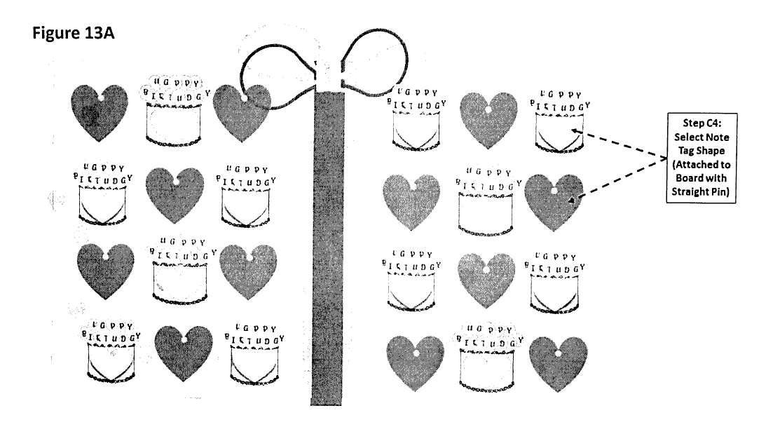

FIG. 12 illustrates a front view of two completed Art Scenes created from certain design elements of an Art Kit including a white Art Board covered in decorative fabric/paper and possibly a ribbon and bow. The flowchart of FIG. 11 outlines the steps of the method for creating the completed Art Scenes of FIG. 12.

In Step 1, the Consumer selects an Event, which thereby selects the relevant Art Kit. In the example of FIG. 12, the Events are a Birthday Party and a Graduation, respectively.

In Step 2, the Consumer selects the size and material for the Art Board included in their Art Kit. In an implementation, the Art Boards of FIG. 12 may be an 18-inch by 24-inch stretched cotton canvas stapled to a wooden frame approximately ½ inch deep. Other stretched canvas sizes will be offered, including but not limited to: 16-inch by 20-inch stretched canvas, and 12-inch by 24-inch stretched canvas. Further, other materials may be used for the Art Board, including but not limited to foam board.

In Step C3, the Consumer selects the Art Scene, including a selection of the color of the Art Board. FIG. 12 shows white Art Boards. Other colors will be offered for both the canvas and the foam board. Regardless of the Art Scene selected, the Art Board may be covered with adhesive-backed cork across its full width and length. The adhesive side of the cork is pressed against the front of the Art Board to attach the cork thereto. In some implementations, the Art Board and the cork layer may then be covered with cotton batting that wraps around the back of the Art Board. The cotton batting may be affixed with spray/stick glue on the front and stapled to the back of the canvas frame of the Art Board.

Decorative fabric or paper may be used to create a background for the Art Scene. The decorative fabric or paper may be affixed over the Art Board, or cotton batting, using spray/stick glue on the front of the Art Board. The decorative fabric or paper may wrap around the edges of the Art Board and be affixed thereto by stapling the decorative fabric or paper to the back of the canvas frame of the Art Board.

The Art Scene look and feel is completed with the addition of decorative elements. In FIG. 12, a “Wrapped Box” is created to signify an Art Scene for a Birthday, and a Quilt with a background of Graduation Caps creates the Graduation Art Scene. The Consumer may place Mounting Corners (included in the Art Kit) in the center of the “Graduation Quilt,” to retain an image or information as decided by the Consumer. A piece of card stock may be included in the Art Kit for the Consumer's use in printing. However, the Consumer may opt to use another type of material to complete the personalization of the Graduation Quilt.

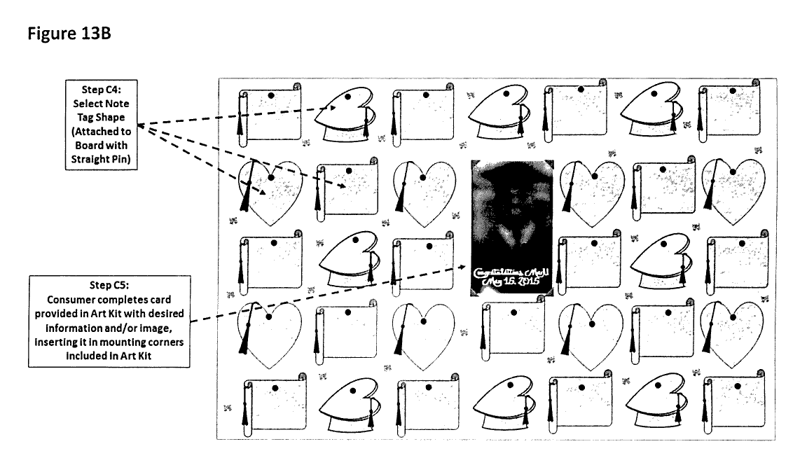

FIGS. 13A and 13B illustrate front views of completed works of art formed by pinning Special Note Tags from the Art Kit to the two (2) different Art Scenes depicted in FIG. 12, respectively. The flowchart of FIG. 11 continues the steps of the method for creating the completed works of art of FIGS. 13A and 13B.

In Step C4, the Consumer selects the Special Note Tags upon which event attendees will write their sentiments. The Special Note Tags may be made of paper and pre-cut into proprietary designs.

At the commemorative event for the celebrated guest, such as the Birthday Party of Graduation, event attendees may write their thoughts and sentiments on the Special Note Tags using felt tipped pens included in the Art Kit. The Special Note Tags are then pinned to the Wrapped Gift or the Graduation Quilt and surrounding area using straight pins, and as needed, stick glue. The straight pins may be secured by pressing them through the Special Note Tag, Wrapped Gift/Graduation Quilt material, cork backing and the Art Board.

FIG. 13A illustrates a front view of the Wrapped Gift as a completed work of art with Stylized Birthday Cake and Heart Note Tags. FIG. 13B depicts the Graduation Quilt as a completed work of art with Diplomas with Tassels, Hearts with Tassels and Graduation Caps with Heart-Shaped Tops Note Tags.

For the Graduation Quilt, the flowchart of FIG. 11 includes an additional Step C5 wherein the Consumer inserts an image of the graduate and/or prints information on a piece of cardstock in the Art Kit. FIG. 13B depicts the Graduation Quilt with Personalized Image/Information as a completed work of art with Special Note Tags, plus an image of a graduate along with his name and graduation date printed on a piece of cardstock and inserted by the Consumer into the Mounting Corners to complete the design.

The system for creating a work of art as disclosed herein may be purchased by Consumers through a variety of different trade channels, including but not limited to: online retail stores and other online venues; “brick and mortar” retail stores and other physical venues; and at special events, such as bridal shows, Quinceaneras dress shows, and other special events.

When a Consumer purchases the system through an online venue, the Consumer may be presented with screen shots displaying a variety of options for each design element of the Art Kit, and the Consumer may then separately select each desired design element to form a customized Art Kit for purchase. In some implementations, the Consumer may then be presented with a screen shot displaying the Art Scene that should result from the customized Art Kit. The Consumer may also be presented with screen shots displaying a variety of options for the Special Note Tags, and the Consumer may then select the desired Special Note Tags for purchase.

In other implementations where a Consumer purchases the system through an online venue, the Consumer may be presented with screen shots displaying partially or fully completed Art Scenes, and the Consumer may then select the Art Kit corresponding to the desired Art Scene for purchase. The Consumer may also have the option of modifying or upgrading certain design elements of the selected Art Kit, such as upgrading from a white Bouquet to a pink Bouquet, or modifying the shape of the Special Note Tags, for example.

When a Consumer purchases the system through a physical venue or at a special event, the Consumer may be presented with a catalog or other physical display of the variety of options for each design element of the Art Kit, and the Consumer may make desired selections from that catalog or other physical display. In some implementations, the catalog or physical display will include representative samples of various design elements, including but not limited to: samples of fabric covered Art Boards, samples of foam Art Boards, samples of Paper Dolls, swatches of decorative fabric, swatches of decorative paper, samples of Tulle, samples of Veil options, samples of Jewelry options, samples of Bouquet options, samples of other decorative features, samples of Special Note Tags, samples of completed Art Scenes, and/or samples of completed works of art.

In other implementations where a Consumer purchases the system through a physical venue or at a special event, the Consumer may be presented with partially or fully completed Art Scenes. The Consumer may then select the Art Kit corresponding to the desired Art Scene, or the partially or fully completed Art Scene, for purchase. The Consumer may also have the option of modifying or upgrading certain design elements of the selected Art Kit or Art Scene, such as upgrading from a white Bouquet to a pink Bouquet, or modifying the shape of the Special Note Tags, for example. Such design elements may be purchased individually through an online venue or a physical venue, or at a special event.

Regardless of the trade channel through which Consumers purchase the system, a Consumer may receive the purchased system in a variety of different formats, including but not limited to: an Art Kit of unassembled design elements that the Consumer assembles into an Art Scene and into a completed work of art; and an Art Board with a partially or fully assembled Art Scene along with an Art Kit providing additional design elements to create the completed work of art. In some implementations, the Art Kit purchased by the Consumer may or may not include certain standard items needed to create the Art Scene or the completed work of art, including, but not limited to: glue, staples, a stapler, quilting tacks, a quilt-tacking gun, felt tipped pens, and push pins.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, and composition of matter, means, methods and steps described in the specification. As one of ordinary skill in the arts will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for creating a work of art to commemorate a life event, comprising:
an art kit having a template design of a pre-printed doll with a dress skirt and other design elements;
a mounting board to which the template design and at least some of the other design elements are secured to create an art scene; and
special note tags adapted to receive written sentiments from guests attending the life event;
wherein the special note tags with written sentiments are secured to the mounting board to complete the work of art.

2. The system of claim 1, wherein the special note tags are secured to the mounting board to cover portions of the art scene to complete the work of art.

3. A system of claim 2, wherein the special note tags are secured to the dress skirt to create a three-dimensional aspect to the dress skirt.

4. The system of claim 1, wherein the art scene is a bride in a bridal dress.

5. The system of claim 1, wherein the art scene is a young woman in a Quinceanera dress.

6. A system for creating a work of art to commemorate a life event, comprising:
an art kit having design elements; and
a mounting board to which at least some of the design elements are affixed to create an art scene.

7. The system of claim 6, wherein the design elements include a template design.

8. The system of claim 7, wherein the template design is a pre-printed doll.

9. The system of claim 8, wherein the art scene is a bride in a bridal dress.

10. The system of claim 8, wherein the art scene is a young woman in a Quinceanera dress.

11. The system of claim 8, wherein the art scene is a baby in a bassinet.

12. The system of claim 8, wherein the art scene is a baby under a quilt.

13. The system of claim 6, wherein the design elements include one or more of:
decorative fabrics, decorative papers, and decorating materials.

14. The system of claim 6, further comprising:
special note tags adapted to receive written sentiments;
wherein the special note tags with written sentiments are secured to the mounting board to complete the work of art.

15. The system of claim 14, wherein the special note tags are secured to the mounting board using push pins or adhesive.

16. The system of claim 14, wherein the special note tags are secured to the mounting board to cover portions of the art scene to complete the work of art.

17. A method for creating a work of art to commemorate a life event comprising:
selecting an art kit corresponding to the life event;
selecting design elements from a plurality of design elements included in the art kit; and
arranging the selected design elements into an art scene.

18. The method of claim 17, further comprising:
selecting special note tags upon which guests attending the life event write sentiments; and
attaching the special note tags with the written sentiments to the art scene to complete the work of art.

19. The method of claim 18, wherein attaching the special note tags comprises covering portions of the art scene to complete the work of art.

20. The method of claim 18, wherein attaching the special note tags comprises creating a three-dimensional aspect to the art scene to complete the work of art.
